(19) United States
(12) Patent Application Publication
(10) Pub. No.: US 2008/0031133 A1
(43) Pub. Date: Feb. 7, 2008

(54) Transmission of time-dependant data

(76) Inventor: Benjamin A. Kendall, Boise, ID (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/498,022

(22) Filed: Aug. 2, 2006

(51) Int. Cl. H04L 12/26

(52) U.S. Cl. 370/231

(57) ABSTRACT

A system and method for dynamically timing the sending of an acknowledgment packet across a network. In one example embodiment, such a method includes determining that a receive data window contains unacknowledged data, determining whether the time since receiving the earliest unacknowledged data packet in the receive data window is less than a pre-determined deferred acknowledgment time, and determining whether the portion of the receive data window with unacknowledged data is less than a dynamically-determined percentage. If the time since receiving the earliest unacknowledged data packet in the receive data window is less than the pre-determined deferred acknowledgment time and the portion of the receive data window with unacknowledged data is less than the dynamically-determined percentage, the method further includes deferring the sending of an acknowledgment packet.

### BACKGROUND

Network performance and efficiency is crucial when streaming time-dependant content from a remote server to a networked client. For instance, when streaming DVD quality video from one computer to another computer across a network, proper presentation of the streaming video to the end user depends on the performance, efficiency and reliability of the network.

When time-dependent content is streamed over an unreliable or inefficient network, negative streaming effects can cause the content to be adversely affected. For example, the performance of some wireless (“WiFi”) networks is variable depending on environmental conditions. WiFi networks in particular are susceptible to radio interference generated by common household appliances such as microwave ovens and cordless phones. As packets of time-dependent data are transmitted across a WiFi network, such environmental conditions can cause problems with packet delivery such as dropped packets, corrupted packets and/or delayed delivery of packets. Such problems can degrade the presentation of the time-dependant content to the end user. For example, the display of a streaming video may skip, glitch, pause or otherwise have noticeable and unacceptable audio and/or video effects because of problems with the delivery of one or more packets containing the streaming video data.

Some attempts have been made to optimize unreliable or inefficient networks. These attempts are aimed at decreasing unnecessary traffic across the network in order to speed up the reception of time-dependent content. However, these attempts at optimization of unreliable or inefficient networks are generally static and do not account for networks where the performance is variable depending on, for example, environmental conditions.

The subject matter claimed herein is not limited to embodiments that solve any disadvantages or that operate only in environments such as those described above. Rather, this background is only provided to disclose one exemplary technology area where some embodiments described herein may be practiced.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention may include systems and methods for controlling the use of “positive acknowledgement” packets. Current embodiments provide the ability to dynamically change when to send an acknowledgment packet across a network based on, for example, time-dependent stream requirements and network conditions. For example, in one embodiment, a method includes determining that a receive data window contains unacknowledged data, determining whether a time since receiving an earliest unacknowledged data packet in the receive data window is less than a pre-determined deferred acknowledgment time, and determining whether a portion of the receive data window with unacknowledged data is less than a dynamically-determined percentage. If the time since receiving the earliest unacknowledged data packet in the receive data window is less than the pre-determined deferred acknowledgment time and the portion of the receive data window with unacknowledged data is less than the dynamically-determined percentage, the method further includes deferring the sending of an acknowledgment packet.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are disclosed in the appended drawings. Understanding that these drawings depict only typical embodiments and are not therefore to be considered to be limiting in scope, embodiments will be described and explained with additional specificity and detail through the use of the accompanying drawings in which:

FIG. 1 discloses an overview of an example system for delivering media content to users;

FIG. 2 discloses a block-diagram of an example media player;

FIG. 3A discloses an example receive data window having a first set of data;

FIG. 3B discloses the example receive data window of FIG. 3A having a second set of data; and

FIG. 4 discloses an example method for dynamically timing the sending of an acknowledgment packet.

### DETAILED DESCRIPTION OF EXAMPLE EMBODIMENTS

As noted above, example embodiments of the invention relate to methods for dynamically altering the timing associated with the sending of acknowledgment packets across a network. An acknowledgment packet is generally sent by a receiving computer to acknowledge that a data packet has been received. Acknowledgment packets can be used in conjunction with network protocols that provide a reliable delivery network layer, such as TCP/IP. However, in consequence of bandwidth limitations and other limiting network characteristics of various network technologies, the timing associated with sending acknowledgment packets can be crucial to the network performance. Among other things, the example methods disclosed herein provide dynamic criteria whereby the timing associated with sending acknowledgment packets can be dynamically optimized over a range of network performance conditions. This timing optimization can be used to efficiently stream time-dependent audio/video data using inefficient network technologies, such as WiFi. The term “time-dependent audio/video stream” as used herein is defined as a stream of data containing digital audio and/or video material that is capable of being at least partially presented to a user before the entire stream has been received.

WiFi networks are half-duplex packet-switched networks. Half-duplex packet-switched networks allow for alternating transmission of packets in two directions, but not in both directions simultaneously. Therefore, unlike fill-duplex packet switched networks, half-duplex packet-switched networks do not allow packets to be sent and received simultaneously. Compared to full-duplex networks, half-duplex networks consume more bandwidth. Therefore, decreasing the bandwidth consumed by sending acknowledgement packets has the effect of increasing the bandwidth available for receiving data packets. Increasing the bandwidth available for receiving data packets can improve the presentation of a time-dependant audio/video stream to an end user. For example, the display of a streaming DVD quality video may experience less skipping, glitching, pausing and other noticeable and unacceptable audio and/or video effects because of the increased bandwidth available for receiving data packets.

### I. Example System for Delivering Media Content to Users

The example methods disclosed herein can be implemented in a dual processor system, where the dual processors are interconnected via an interface intended for connection to storage devices such as an IDE interface. IDE interfaces are typically used for storage communication as opposed to processor interconnection. A system may include a specialized media decoder processor which includes specialized hardware for decoding and displaying media data, such as audio, video and/or image data. The decoder processor may be connected via an IDE interface, or other storage based connection, to a network processor that includes functionality for sending and receiving data across a network. By connecting the network processor to the decoder processor through an IDE interface, the network processor can be treated by the decoder processor as an IDE storage device. The network processor can be used to convert storage operations to network operations and vice versa.

The network processor includes an interface for connecting to a network where data can be obtained. For example, the network processor may connect to a server which includes physical storage for storing data. To obtain video or other data, the video decoder processor may send storage device protocol messages across the IDE interface and to the network processor. This is done in a transparent fashion such that the decoder processor treats the network processor as a storage device. The network processor can then obtain data from a server across a network and provide the data to the decoder processor in a fashion similar to how a storage device provides data across an IDE interface. Because data is being obtained by the network processor across a network, network delays may be introduced into the architecture.

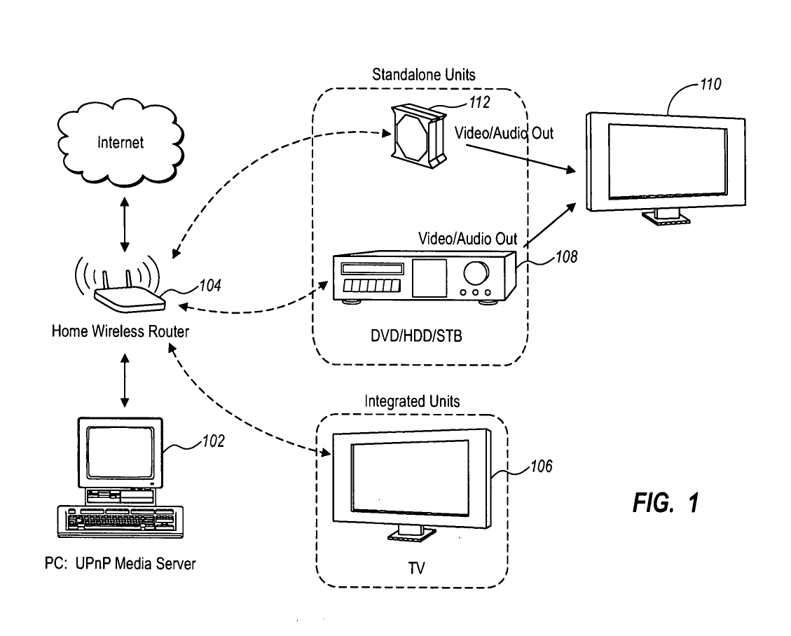

Referring now to FIG. 1, an exemplary environment where some embodiments of the invention may be practiced is disclosed. FIG. 1 discloses a media server 102, which in this example is a universal plug and play (UPnP) server. The media server 102 may store various media files such as music files, video files, and picture files. Generally, the media server 102 is located in a local area network (LAN) and is configured to provide the media files locally to clients. For example, in one embodiment, the media server 102 may be implemented in a home environment to provide media to home users.

In the illustrated embodiment, the media server 102 is connected through a router 104 to various clients in the network. The clients on the network may include specialized media adapters configured to provide media to users. As will be discussed further, the media adapters may include specialized hardware optimized for providing the media to users. For example, the media adapters may include processors that are optimized for decoding compressed audio, video or image data. The media adaptors may be embodied in a number of forms. For example, FIG. 1 illustrates a media adapter integrated into a television 106.

FIG. 1 also discloses a number of standalone units. For example, the media adapter may be integrated into a DVD player 108. This embodiment is particularly interesting because the encoding on DVDs is often the same as the encoding for stored video files or over the air (OTA) transport streams. Thus, the specialized hardware can be used both for decoding DVD signals as well as decoding data streamed from the media server 102 to the media adapter in the DVD player 108. The DVD player 108 is connected through audio and video connections to a television 110 where the DVD video can be played or where the media data from the media server 102 can be displayed.

FIG. 1 further discloses a self contained media adapter 112. The self contained media adapter 112 includes the specialized hardware for decoding and displaying media streamed from the media server 102. The self contained media adapter 112 is connected to the television 110 through audio and video connections.

Each of the media adapters, whether embodied as an integrated unit or as a standalone unit, is connected, in this example, through the router 104 to the media server 102. The connections between the media server 102, router 104 and media adapters may be any suitable network connection including hardwired Ethernet connections, wireless WiFi connections, or any other suitable connection. Notably, some embodiments described herein optimize wireless network connections to maintain suitability for transmitting high bit rate media files.

### II. Example Media Player

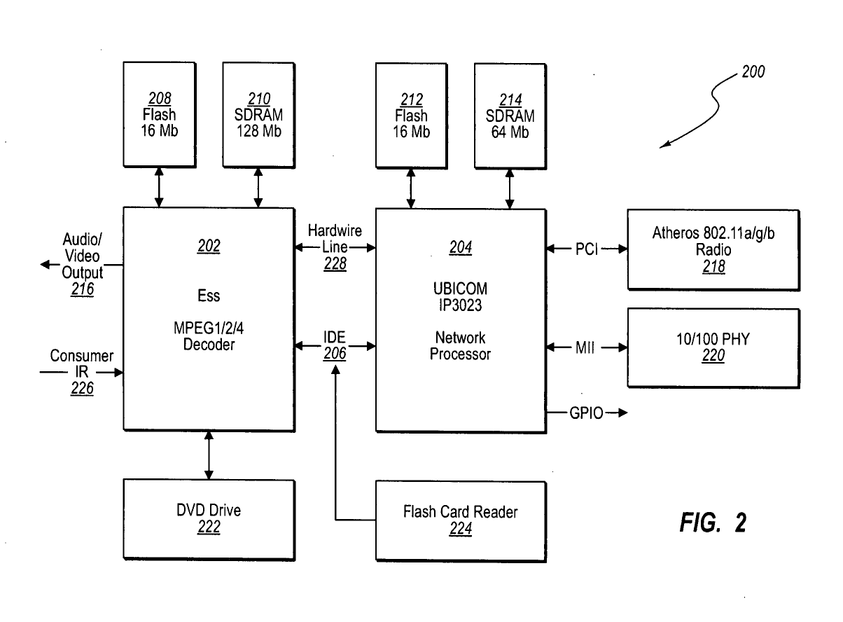

Referring now to FIG. 2, one example of the hardware used to implement a media adapter, designated generally at 200, is disclosed. As described previously, in the illustrated embodiment the media adapter 200 includes two processors that are coupled by an IDE bus. While an IDE bus is disclosed here, other storage device type busses may also be used. The media adapter 200 includes an mpeg decoder processor 202 coupled to a network processor 204 through an IDE bus 206. Each of the processors 202, 204 includes other appropriate peripheral hardware depending on the needs of a particular application. For example, in one embodiment the decoder processor 202 is coupled to flash memory 208 and DRAM memory 210. The flash memory and DRAM memory 210 may store computer executable instructions such as computer applications to be executed on the decoder processor 202. Additionally, the DRAM memory 210 may store data from the network processor 204, such as audio, video, or image data. The data stored in the DRAM memory 210 can be displayed by sending audio and video signals through the audio video output line 216. Notably, the audio video output line 216 may be any one of a number of formats including various combinations of composite, component video, HDMI, DVI, and the like.

Similar to the decoder processor 202, the illustrated network processor 204 has a flash memory 212 and a DRAM memory 214 connected to it. The flash memory 212 and DRAM memory 214 are computer readable media that may include computer executable instructions that can be executed by the network processor 204. In addition, the DRAM memory 214 may store data for delivery to the decoder processor 202. For example, the network processor 204 may receive data from a data store such as the media server 102. This data may be stored in the DRAM memory 214 for delivery to the decoder processor 202. Such data may include for example, media, file information, directory information, or other information. In this example, the network processor 204 may be connected to a media server through one or more different network connections.

FIG. 2 discloses both wired and wireless connections. For example, the network processor may be connected through a PCI bus connection to a wireless radio 218. In this example, the wireless radio 218 supports IEEE 802.11a, b, and g wireless signals. IEEE 802.11a and g may be advantageous for video transmission as they are able to handle media streams at higher bit rates than IEEE 802.11b transmissions. The wireless radio 218 may communicate with a wireless router, such as the router 104 shown in FIG. 1. The wireless router 104 can then communicate with the media server 102, either wired or wirelessly, for completing the connection between the network processor 204 and the media server 102.

FIG. 2 further discloses that the network processor 204 may communicate with the media server through a wired connection such as by using a standard 10/100 Mbs (megabits per second) Ethernet adapter, denoted at 220. Similar to the wireless example, the Ethernet adapter 220 may be connected to the router 104, which is in turn connected to the media server 102. While in this example a 10/100 Mbs adapter is used, it should be appreciated that Gigabit Ethernet adapters, or any other suitable adapter, whether wired or wireless, may be used.

FIG. 2 discloses two additional options. The first is a DVD drive 222 connected to the decoder processor 202. As explained previously, often the encoding on DVDs is the same as the encoding for other video and audio files. As such, the specialized hardware on the decoder processor 202 is especially suited for decoding DVD video. As such, a more functional device may be implemented where the device includes a DVD drive 222 such that DVD video can be played from the device. Such a device is disclosed in FIG. 1 at 108.

FIG. 2 discloses a second option, which includes a flash card reader 224 connected to the decoder processor 202 through the IDE bus 206. This option allows users to display media from a portable flash card using the media adapter 200. For example, flash cards from digital cameras or camcorders can be plugged directly into the flash card reader 224 obviating the need to store the media on the media server 102 prior to viewing the media using the media adapter 200. One or more alternatives for the flash card reader 224 may be provided. For example, the flash card reader 224 may have provisions for compact flash, secure digital, multimedia, etc. Additionally, in one embodiment, the flash card reader 224 may include a USB interface for connecting directly to a USB flash storage device or USB connectable hard-disk drive.

Again, in the illustrated example the two processors, the decoder processor 202 and network processor 204, are connected through an IDE bus 206. Ordinarily such communications would take place on a PCI or other type of communication bus. Typically, an IDE bus is used for connecting storage to a processor. However, by using an IDE bus 206 to connect to the decoder processor 202 and network processor 204, several advantages can be realized. For example, typical decoder processors come equipped with a standard IDE bus interface for connecting storage to the decoder processor. However, some decoder processors may not come equipped with network connectivity, and as such may not be suitable on their own for use in a media adapter connectable in a network. By using the IDE bus interface (or similar storage connection-oriented bus interface) to connect through an IDE bus to a network processor, networking functionality can be added to virtually any media decoder processor.

This type of configuration allows for a number of other advantages as well, including: the ability to use a smaller operating system, easier selection of a specialized network processor, easy replacement of the network processor in subsequent designs when additional networking speeds and functionality become available, easy replacement of the decoder processor in subsequent designs, reduced memory requirements, etc.

Ordinarily, a storage device connected to a host processor through an IDE bus is somewhat passive in nature. In other words, an IDE device typically accepts commands from the host processor, and can be polled by the host processor for information, but does not usually provide data to the host processor without first being prompted. In the example shown in FIG. 2, the decoder processor 202 assumes the role of the host processor and the network processor 204 assumes the role of the device in the IDE connection. To facilitate the network processor 204 providing information to the decoder processor 202, in the example embodiment a hardware line 228 connects the two processors. If the network processor 204 has information to pass to the decoder processor 202, the network processor 204 can set the line signaling to the decoder processor 202 that the network processor 204 has information to pass to the decoder processor 202. The decoder processor 202 can then poll the information from the network processor 204. Such information may include, among other things, diagnostic information.

For example, the network processor 204 may be able to detect various conditions such as a storage device not being connected to one of the network connections 218, 220, or the inoperability of the network. The network processor 204 can thus signal on the hardware line 228 that it has data for the decoder processor. When the decoder processor 202 polls the network processor 204, the network processor 204 can provide the diagnostic information.

In the illustrated example, the particular decoder processor 202 shown is an MPEG1/2/4 decoder, which may be implemented using part numbers ES6425FF, ES8381FCD, or ES6430FAA available from ESS Technology, Inc. located in Fremont Calif. While any one of a number of different devices/implementations could be used, these particular decoders include various hardware components including a central processing unit, a DMA state machine, an interrupt state machine and a media player state machine. The central processing unit coordinates interactions between the different state machines and generally manages data flow and decoding activities. The DMA state machine manages DMA data requests to perform DMA data handling. The interrupt state machine generally includes a number of registers and indicators indicating active interrupts for obtaining service from the central processing unit from other components including components included in the decoder processor 202. The media player state machine includes functionality for controlling how media is accessed and played for a user. For example, the media player state machine may include functionality for implementing play, pause, fast-forward, rewind, etc. This can be used to control what data is requested, and when the data is requested.

### III. Example Receive Data Window

Some network protocols over which data is received by a media player require that the received data be acknowledged by the media player. For example, where a media player is connected to a WiFi network utilizing TCP/IP, each data packet received by the media player must be acknowledged by the media player. This acknowledgement of received data packets is accomplished by sending an acknowledgment packet to the sender of the data packets. As disclosed elsewhere herein, the timing of sending acknowledgement packets can impact the bandwidth available for receiving data packets in a WiFi network.

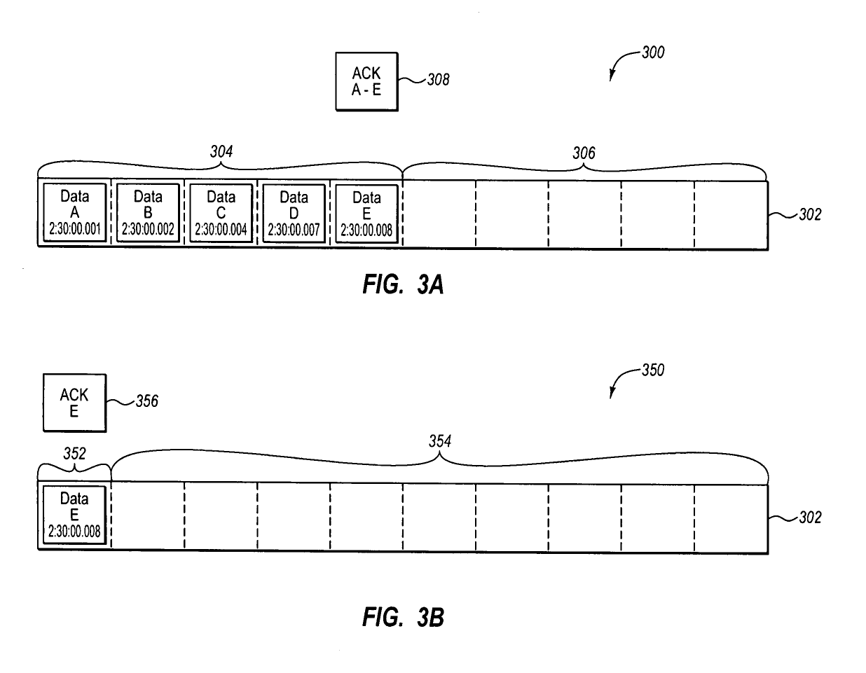

Turning now to FIG. 3A, a scenario is disclosed at 300 involving an example receive data window 302. The receive data window 302 defines the amount of received data that can be buffered during a network connection with another computer. For purposes of example, after a network connection is established between the media server 102 and the television 106 of FIG. 1, the receive data window 302 of the television 106 can define a buffer capable of holding 60 kilobytes of data. Data amounts less than or greater than 60 kilobytes are also possible. For example, a receive data window in TCP can define a buffer as large as 1 gigabyte using a TCP window scale option.

As disclosed in FIG. 3A, a portion 304 of the receive data window 302 contains unacknowledged data packets A-E that were received by the receive data window 302 at 2:30:00.001 p.m., 2:30:00.002 p.m., 2:30:00.004 p.m., 2:30:00.007 p.m., and 2:30:00.008 p.m., respectively. Each of data packets A-E includes 6 k of data. As a result of having received the data packets A-E, the free space 306 of the buffer 302 has been reduced by 50%. In other words, only 30 k, or 50%, of the 60 k capacity of the receive data window 302 is available for receiving additional data packets.

As disclosed in FIG. 3A, an acknowledgment packet 308 can be sent to acknowledge receiving data packets A-E. For example, after having received data packets A-E from the media server 102, the television 106 can send the acknowledgment packet 308 to the media server 102 in order to acknowledge having received the data packets A-E.

Turning now to FIG. 3B, the receive data window 302 is disclosed in a second scenario 350. In this second scenario 350, a portion 352 of the receive data window 302 contains an unacknowledged data packet E that was received at 2:30:00.008 p.m. As with the data packet E in FIG. 3A, the data packet E in FIG. 3B includes 6 k of data. As a result of having received the data packet E, the free space 354 of the receive data window 302 has been reduced by 6 k, or 10%. In other words, only 54 k, or 90%, of the 60 k capacity of the receive data window 302 is available for receiving additional data packets.

As disclosed in FIG. 3B, an acknowledgment packet 356 can be sent to acknowledge receiving data packet E. For example, after having received data packet E from the media server 102, the television 106 can send the acknowledgment packet 356 to the media server 102 in order to acknowledge having received the data packet E.

### IV. Example Method for Dynamically Timing an Acknowledgment Packet

As disclosed elsewhere herein, limited network bandwidth for receiving data packets can cause the display of a time-dependent digital audio/video stream to skip, glitch, pause or otherwise have noticeable and unacceptable audio and/or video effects. Decreasing the bandwidth used for sending acknowledgment packets can increase the bandwidth for receiving data packets. Therefore, the timing associated with sending acknowledgment packets can be crucial to network performance.

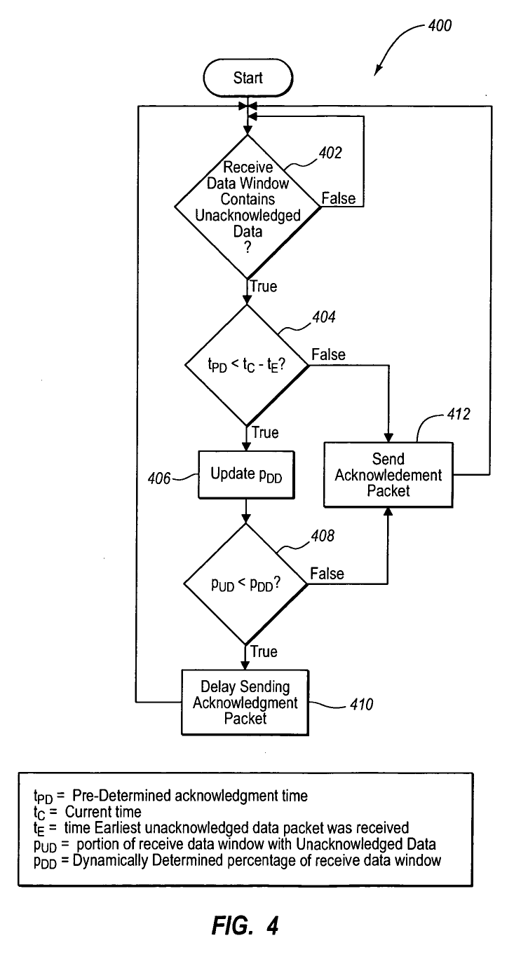

With continued reference to FIGS. 1, 2, 3A and 3B, and now also with reference to FIG. 4, an example method for dynamically timing the sending of an acknowledgment packet is disclosed by way of a series of process steps designated at 400. In the disclosure of the method 400 below, various examples of each of the acts of the method 400 will be given. It is assumed for the purpose of these examples that the television 106 of FIG. 1 includes a media adapter having a hardware configuration similar to the media adapter 200 of FIG. 2. It is also assumed for the purpose of these examples that the processor 204 of FIG. 2 is in communication with one or more computer-readable media which carries computer-executable instructions which enable the processor 204 to perform each of the acts disclosed in connection with the method 400.

Method 400 includes an act 402 of determining whether a receive data window contains unacknowledged data. If the receive data window does not contain unacknowledged data, the method 400 repeats the act 402 until it is determined that the receive data window does contain unacknowledged data. When it is finally determined that the received data window does contain unacknowledged data, then the method 400 proceeds to an act 404, described below.

For example, the network processor 204 of the television 106 can determine that the receive data window 302 contains at least one unacknowledged data packet. In either scenario 300 or scenario 350, the unacknowledged data in the receive data window 302 can be digital audio/video data that was streamed from the UPnP media server 102 by way of the wireless router 104.

Method 400 also includes an act 404 of determining whether the time since the time t_{E} that the earliest unacknowledged data packet in the receive data window was received is less than a pre-determined deferred acknowledgment time t_{PD}. In other words, the act 404 involves determining whether t_{PD}<t_{C}−t_{E}, where t_{C} is the current time.

For example, the pre-determined deferred acknowledgment time t_{PD} for the processor 204 of television 106 may be 7 milliseconds. In the scenario 300 disclosed in FIG. 3A, the earliest unacknowledged data packet in the receive data window 302 was received by the network processor 204 at t_{E}=2:30:00.001 p.m. and the current time is t_{C}=2:30:00.008. Therefore, the network processor 204 will determine that 7 milliseconds have passed since the earliest unacknowledged data packet was received in the receive data window 302. Therefore, the processor 204 will determine that the condition of the act 404 is false, since the 7 millisecond time lapse (t_{C}−t_{E}) is not less than the 7 millisecond pre-determined deferred acknowledgment time t_{PD}.

On the other hand, in the scenario 350 disclosed in FIG. 3B, each data packet received by the network processor 204 before the reception of the data packet has already been acknowledged by the network processor 204. In the scenario 350 disclosed in FIG. 3B, therefore, the earliest unacknowledged data packet in the receive data window 302 is also the most recently received unacknowledged data packet, namely data packet E. Therefore, the network processor 204 will determine that difference between the current time of t_{C}=2:30:00.008 p.m. and the time that the data packet E was received of t_{E}=2:30:00.008 p.m. is 0 milliseconds. Therefore, the processor 204 will determine that the condition of the act 404 is true, since the 0 millisecond time lapse (t_{C}−t_{E}) is less than the 7 millisecond pre-determined deferred acknowledgment time t_{PD}.

Method 400 also includes an act 406 of updating a dynamically-determined percentage P_{DD} of the receive data window. This dynamically-determined percentage P_{DD} is not constant and, therefore, may change any time before the performance of an act 408, as discussed below, based on a number of factors.

For example, the dynamically-determined percentage P_{DD} updated in the act 406 can be dynamically determined, at least in part, proportional to the average amount of time between sending an acknowledgment packet and receiving the next data packet. For example, as the average amount of time between sending an acknowledgment packet and receiving the next data packet increases, the dynamically-determined percentage P_{DD} updated in the act 406 can also be proportionally increased.

In addition, the dynamically-determined percentage P_{DD} updated in the act 406 can be dynamically determined, at least in part, inversely proportional to the time that a time-dependent audio/video stream currently being received can continue to be presented uninterrupted without additional data. For example, the data packets A-E of FIG. 3A can constitute a portion of a time-dependent audio/video stream. At the same time that the data packets A-E are being received, another previously received portion of the audio/video stream can be simultaneously presented on one or more user interfaces of the television 106, such as the television screen and the television speakers. As the amount of time that the audio/video stream can continue to be displayed correctly on the screen and speakers of the television 106 without receiving additional data decreases, the dynamically-determined percentage P_{DD} updated in the act 406 can be proportionally increased.

Furthermore, the dynamically-determined percentage P_{DD} updated in the act 406 can also be dynamically determined, at least in part, inversely proportional to the number of bytes received in each data packet. For example, as the data packets received by the buffer 302 increase in size, the dynamically-determined percentage P_{DD} updated in the act 406 can be proportionally decreased.

Method 400 also includes an act 408 of determining whether the portion P_{UD} of the receive data window with unacknowledged data is less than a dynamically-determined percentage P_{DD}. In other words, the act 408 involves determining whether P_{UD}<P_{DD}.

For example, in the scenario 300 disclosed in FIG. 3A, after receiving the data packet E, the portion 304 of the receive data window 302 that contains unacknowledged data constitutes 50% of the capacity of the receive data window 302. As disclosed above, the portion 304 of the receive data window 302 is occupied by the data packets A-E. In the scenario 350 disclosed in FIG. 3B, on the other hand, after receiving the data packet E, the portion 352 of the receive data window 302 that contains unacknowledged data constitutes only 10% of the capacity of the received data window 302. As disclosed above, the portion 352 of the received data window 302 is occupied only by the data packet E.

If the conditions of the acts 404 and 408 are determined to be true, then the method 400 also includes an act 410 of delaying the sending of an acknowledgement packet. If, however, the conditions of either the acts 404 or the act 408 are determined to be false, then the method 400 includes an act 412 of sending an acknowledgement packet for all of the unacknowledged data packets in the receive data window.

For example, in the scenario 300 of FIG. 3A and assuming a pre-determined deferred acknowledgment time of 7 milliseconds, since the earliest unacknowledged data packet in the receive data window 302 was received 7 milliseconds prior to the performance of the act 404, then the condition of the act 404 will be false, and the processor 404 will send the acknowledgement packet 308 to acknowledge having received the data packets A-E. In the scenario 350 of FIG. 3, on the other hand, since the earliest unacknowledged data packet in the receive data window 302 was received 0 milliseconds prior to the performance of the act 404, then the condition of the act 404 will be true. Assuming a dynamically-determined percentage of 25%, since the unacknowledged data packets occupy a portion 356 totaling only 10% of the receive data window 302, the condition of the act 406 will also be true. The processor 404 will therefore delay sending the acknowledgement packet 314.

As disclosed in FIG. 4, subsequent to the performance of either the act 410 or the act 412, the method 400 then repeats with the act 402 of determining whether a receive data window contains unacknowledged data. In the example above involving scenario 350, if during some subsequent iteration of the act 404 the current time becomes t_{C}=2:30:00.015 p.m., then the network processor 204 will determine that 7 milliseconds have passed since t_{E}=2:30:00.008 p.m. when the earliest unacknowledged data packet in the receive data window 302 was received. Therefore, the processor 204 will determine that the condition of the act 404 is false, since the 7 millisecond lapse (t_{C}−t_{E}) is not less than the pre-determined deferred acknowledgment time t_{PD} of 7 milliseconds. The method 400 will then proceed to the act 412 of sending an acknowledgement packet 356 corresponding to the data packet E. This example illustrates that an acknowledgement packet will eventually be sent due to the passage of time resulting in a false condition in the act 404, even where no additional data packets are received

The example method 400 can be implemented using computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for dynamically timing the sending of an acknowledgment packet across a network, the method comprising the acts of:
a) determining that a receive data window contains unacknowledged data;
b) determining whether a time since receiving an earliest unacknowledged data packet in the receive data window is less than a pre-determined deferred acknowledgment time;
c) determining whether a portion of the receive data window with unacknowledged data is less than a dynamically-determined percentage; and
d) if the conditions of b) and c) are true, deferring the sending of an acknowledgment packet.

2. The method as recited in claim 1, wherein the dynamically-determined percentage is dynamically determined, at least in part, proportional to an average amount of time between sending an acknowledgment packet and receiving the next data packet.

3. The method as recited in claim 1, wherein the unacknowledged data in the receive data window comprises a time-dependent audio/video stream, where at least a portion of the audio/video stream is simultaneously being presented on one or more user interfaces.

4. The method as recited in claim 3, wherein the dynamically-determined percentage is dynamically determined, at least in part, inversely proportional to a time that the time-dependent audio/video stream can continue to be presented uninterrupted without additional data.

5. The method as recited in claim 1, wherein the dynamically-determined percentage is dynamically determined, at least in part, inversely proportional to a number of bytes received in each data packet.

6. The method as recited in claim 1, further comprising:
sending an acknowledgment packet for all unacknowledged data packets if the condition of b) is false.

7. The method as recited in claim 1, further comprising:
sending an acknowledgment packet for all unacknowledged data packets if the condition of c) is false.

8. The method as recited in claim 1, further comprising the act of repeating acts a), b), c) and d).

9. A method for dynamically altering when to send an acknowledgment packet across a wireless network, the method comprising the acts of:
a) determining that a receive data window contains unacknowledged data of a time-dependent audio/video stream;
b) determining whether a time since receiving an earliest unacknowledged data packet in the receive data window is less than a pre-determined deferred acknowledgment time;
c) determining whether an amount of the receive data window with unacknowledged data is less than a dynamically-determined percentage; and
d) if the conditions of b) and c) are true, deferring the sending of an acknowledgment packet via the wireless network.

10. The method as recited in claim 9, wherein the dynamically-determined percentage is dynamically determined, at least in part, proportional to an average amount of time between sending an acknowledgment packet and receiving the next data packet.

11. The method as recited in claim 9, where at least a portion of the audio/video stream is simultaneously being presented on one or more user interfaces.

12. The method as recited in claim 11, wherein the dynamically-determined percentage is dynamically determined, at least in part, inversely proportional to the time that the time-dependent audio/video stream can continue to be presented uninterrupted without additional data.

13. The method as recited in claim 9, wherein the dynamically-determined percentage is dynamically determined, at least in part, inversely proportional to the number of bytes received in each data packet.

14. The method as recited in claim 9, further comprising:
sending an acknowledgment for all unacknowledged data packets if the condition of b) is false.

15. The method as recited in claim 9, further comprising:
sending an acknowledgment packet for all unacknowledged data packets if the condition of c) is false.

16. The method as recited in claim 9, further comprising the act of repeating acts a), b), c) and d).

17. A computer program product comprising one or more computer-readable media having thereon computer-executable instructions that when executed by one or more processors of a computer system, cause the computer system to perform a method for dynamically altering when to send an acknowledgment packet across a network, the method comprising:
a) determining that a receive data window contains unacknowledged data;
b) determining whether a time since receiving an earliest unacknowledged data packet in the receive data window is less than a pre-determined deferred acknowledgment time;
c) determining whether an amount of the receive data window with unacknowledged data is less than a dynamically-determined percentage; and
d) if the conditions of b) and c) are true, deferring the sending of an acknowledgment packet.

18. The computer program product as recited in claim 17, wherein the computer readable medium further carries computer-executable instructions for performing the following:
sending an acknowledgment packet for all unacknowledged data packets if the condition of b) is false.

19. The computer program product as recited in claim 17, wherein the computer readable medium further carries computer executable-instructions for performing the following:
an act of sending an acknowledgment packet for all unacknowledged data packets if the condition of c) is false.

20. The computer program product as recited in claim 17, wherein the computer readable medium further carries computer executable-instructions for performing the following:
an act of repeating acts a), b), c) and d).
